(19) United States
(12) Patent Application Publication
(10) Pub. No.: US 2023/0011614 A1
(43) Pub. Date: Jan. 12, 2023

(54) DISCONTINUOUS RECEPTION INTERVAL ADJUSTMENT

(71) Applicants: AT&T Intellectual Property I, L.P., Atlanta, GA (US); AT&T Mobility II LLC, Atlanta, GA (US)

(72) Inventors: Robert Holden, Allen, TX (US); Darwin Parra, Cedar Park, TX (US); Matthew Robertson, Johns Creek, GA (US)

(21) Appl. No.: 17/372,794

(22) Filed: Jul. 12, 2021

(51) Int. Cl. H04W 76/28

(52) U.S. Cl. CPC H04W 76/28

(57) ABSTRACT

The described technology is generally directed towards discontinuous reception interval adjustment. User equipment that is designated to employ an adjusted discontinuous reception interval, which is different from an interval used for other user equipment, can be provisioned to employ higher and lower energy states according to the adjusted discontinuous reception interval. The user equipment can be furthermore provisioned to use a designated quality of service class identifier (QCI) in connection with radio access network (RAN) communications. The designated QCI notifies the RAN to adopt the adjusted discontinuous reception interval in connection with user equipment communications, so the RAN can synchronize inbound communications for the user equipment to occur within the user equipment's higher energy states.

### TECHNICAL FIELD

The subject application is related to cellular communication systems, e.g., to techniques to adjust discontinuous reception intervals used to synchronize user equipment energy states with radio access network transmissions.

### BACKGROUND

Discontinuous reception (DRX) is a method used in cellular communication systems to conserve battery life of user equipment, such as cellular telephones and other devices. A user equipment can schedule time intervals during which the user equipment is either “awake” or otherwise in a higher power state in which a receiver of the user equipment is on and available to receive transmissions from a cellular communication network, or “asleep” or otherwise in a lower power state in which the receiver is off and not available to receive transmissions from the cellular communication network. The user equipment can synchronize with a serving cell or a base station of a radio access network, so that the radio access network will initiate communications with the user equipment during one of the “awake” intervals.

While discontinuous reception is beneficial in lengthening battery life for a majority of user equipment, it can potentially cause unacceptable latency for certain user equipment with low or very low latency requirements. User equipment with low or very low latency requirements can include, e.g., user equipment employed by utility companies, such as switches and other devices, which can be usefully configured to report information and/or receive instructions via cellular communication networks. It can be important for communications with such devices to meet very low latency operational requirements of the utility company. This is one example that happens to include so-called “internet of things” (IoT) type user equipment, which can potentially have low latency requirements, however, other user equipment in many other use case scenarios, including non-IoT scenarios, may also have low latency requirements.

Discontinuous reception can cause unacceptable latency when the user equipment's “sleep” interval is longer than the owner's latency requirement. For example, consider a utility company switch that is specified to be able to receive communications within a latency of 20 milliseconds (ms) or less. If the DRX interval is, e.g., 320 ms, then, when a radio access network base station receives an incoming communication for the switch, the base station will wait up to 320 ms to send the incoming communication to the switch. While it is possible that the base station receives the incoming communication 300 ms or more into a DRX interval, and therefore waits 20 ms or less to send the incoming communication to the switch, it is more likely that the base station receives the incoming communication 299 ms or less into the DRX interval, and therefore waits longer than 20 ms to send the communication to the switch, leading to a failure to meet the 20 ms latency specification.

Simply turning DRX features off for user equipment with low latency requirements, while leaving DRX features on for the majority of other user equipment, is technically feasible, but impractical. DRX features have a sufficiently high number of dependencies within cellular communication systems, such that turning DRX off on a device-by-device basis can be labor intensive and error prone. In this regard, there is a need for other approaches to provide low latency for some user equipment, while continuing to support longer DRX intervals for other user equipment, so that battery life is preserved for user equipment that is not associated with low latency requirements.

The above-described background is merely intended to provide a contextual overview of some current issues and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system, in accordance with various aspects and embodiments of the subject disclosure.

FIG. 2 illustrates example discontinuous reception interval adjustment, in accordance with various aspects and embodiments of the subject disclosure.

FIG. 3 illustrates example provisioning of user equipment to use an adjusted discontinuous reception interval, in accordance with various aspects and embodiments of the subject disclosure.

FIG. 4 illustrates example operations of a network node in connection with discontinuous reception interval adjustment, in accordance with various aspects and embodiments of the subject disclosure.

FIG. 5 illustrates an example user equipment which can be adapted to use an adjusted discontinuous reception interval, in accordance with various aspects and embodiments of the subject disclosure.

FIG. 6 illustrates an example network architecture configured to make use of discontinuous reception interval adjustment, in accordance with various aspects and embodiments of the subject disclosure.

FIG. 7 is a flow diagram representing example operations of network equipment in connection with provisioning user equipment for discontinuous reception interval adjustment, in accordance with various aspects and embodiments of the subject disclosure.

FIG. 8 is a flow diagram representing example operations of a network node in connection with transmissions to user equipment that employs an adjusted discontinuous reception interval, in accordance with various aspects and embodiments of the subject disclosure.

FIG. 9 is a flow diagram representing example operations of user equipment in connection with using an adjusted discontinuous reception interval, in accordance with various aspects and embodiments of the subject disclosure.

FIG. 10 is a block diagram of an example computer that can be operable to execute processes and methods in accordance with various aspects and embodiments of the subject disclosure.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details, and without applying to any particular networked environment or standard.

One or more aspects of the technology described herein are generally directed towards discontinuous reception interval adjustment. In some examples, user equipment that is designated to employ an adjusted discontinuous reception interval, which is different from an interval used for other user equipment, can be provisioned to employ higher and lower energy states according to the adjusted discontinuous reception interval. The user equipment can be furthermore provisioned to use a designated quality of service class identifier (QCI) in connection with radio access network (RAN) communications. The designated QCI notifies the RAN to adopt the adjusted discontinuous reception interval in connection with user equipment communications, so the RAN can synchronize inbound communications for the user equipment to occur within the user equipment's higher energy states.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments have been described herein in the context of 4G, 5G, or other generation networks, the disclosed aspects are not limited to a 4G or 5G implementation, and/or other network next generation implementations, as the techniques can also be applied, for example, in third generation (3G), or other 4G systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), single carrier FDMA (SC-FDMA), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), LTE frequency division duplex (FDD), time division duplex (TDD), 5G, third generation partnership project 2 (3GPP2), ultra mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology. In this regard, all or substantially all aspects disclosed herein can be exploited in legacy telecommunication technologies.

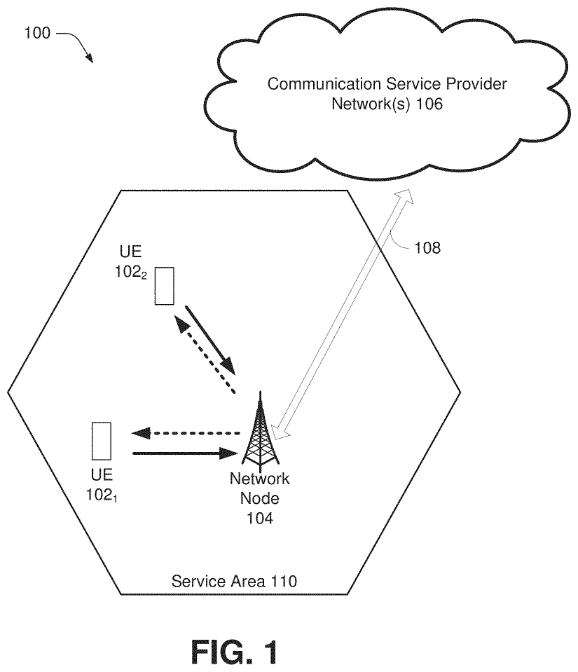

FIG. 1 illustrates a non-limiting example of a wireless communication system 100 which can be used in connection with at least some embodiments of the subject disclosure. In one or more embodiments, system 100 can comprise one or more user equipment UEs 102₁, 102₂, referred to collectively as UEs 102, a network node 104 that supports cellular communications in a service area 110, also known as a cell, and communication service provider network(s) 106.

The non-limiting term “user equipment” can refer to any type of device that can communicate with a network node 104 in a cellular or mobile communication system 100. UEs 102 can have one or more antenna panels having vertical and horizontal elements. Examples of UEs 102 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 102 can also comprise IOT devices that communicate wirelessly.

In various embodiments, system 100 comprises communication service provider network(s) 106 serviced by one or more wireless communication network providers. Communication service provider network(s) 106 can comprise a “core network”. In example embodiments, UEs 102 can be communicatively coupled to the communication service provider network(s) 106 via network node 104. The network node 104 (e.g., network node device) can communicate with UEs 102, thus providing connectivity between the UEs 102 and the wider cellular network. The UEs 102 can send transmission type recommendation data to the network node 104. The transmission type recommendation data can comprise a recommendation to transmit data via a closed loop multiple input multiple output (MIMO) mode and/or a rank-1 precoder mode.

A network node 104 can have a cabinet and other protected enclosures, computing devices, an antenna mast, and multiple antennas for performing various transmission operations (e.g., MIMO operations) and for directing/steering signal beams. Network node 104 can comprise one or more base station devices which implement features of the network node 104. Network nodes can serve several cells, also called sectors or service areas, such as service area 110, depending on the configuration and type of antenna. In example embodiments, UEs 102 can send and/or receive communication data via a wireless link to the network node 104. The dashed arrow lines from the network node 104 to the UEs 102 can encode downlink (DL) communications to the UEs 102. The solid arrow lines from the UEs 102 to the network node 104 represent uplink (UL) communications.

Communication service provider network(s) 106 can facilitate providing wireless communication services to UEs 102 via the network node 104 and/or various additional network devices (not shown) included in the one or more communication service provider network(s) 106. The one or more communication service provider network(s) 106 can comprise various types of disparate networks, including but not limited to: cellular networks, femto networks, picocell networks, microcell networks, internet protocol (IP) networks Wi-Fi service networks, broadband service network, enterprise networks, cloud based networks, millimeter wave networks and the like. For example, in at least one implementation, system 100 can be or comprise a large scale wireless communication network that spans various geographic areas. According to this implementation, the one or more communication service provider network(s) 106 can be or comprise the wireless communication network and/or various additional devices and components of the wireless communication network (e.g., additional network devices and cell, additional UEs, network server devices, etc.).

The network node 104 can be connected to the one or more communication service provider networks 106 via one or more backhaul links 108. For example, the one or more backhaul links 108 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 108 can also comprise wireless link components, such as but not limited to, line-of-sight (LOS) or non-LOS links which can comprise terrestrial air-interfaces or deep space links (e.g., satellite communication links for navigation). Backhaul links 108 can be implemented via a “transport network” in some embodiments. In another embodiment, network node 104 can be part of an integrated access and backhaul network. This may allow easier deployment of a dense network of self-backhauled 5G cells in a more integrated manner by building upon many of the control and data channels/procedures defined for providing access to UEs.

Wireless communication system 100 can employ various cellular systems, technologies, and modulation modes to facilitate wireless radio communications between devices (e.g., the UE 102 and the network node 104). While example embodiments might be described for 4G systems, the embodiments can be applicable to any radio access technology (RAT) or multi-RAT system where the UE operates using multiple carriers, e.g., LTE FDD/TDD, GSM/GERAN, CDMA2000 etc.

For example, system 100 can operate in accordance with any 5G, next generation communication technology, or existing 3G or 4G communication technologies. In this regard, various features and functionalities of system 100 are applicable where the devices (e.g., the UEs 102 and the network device 104) of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

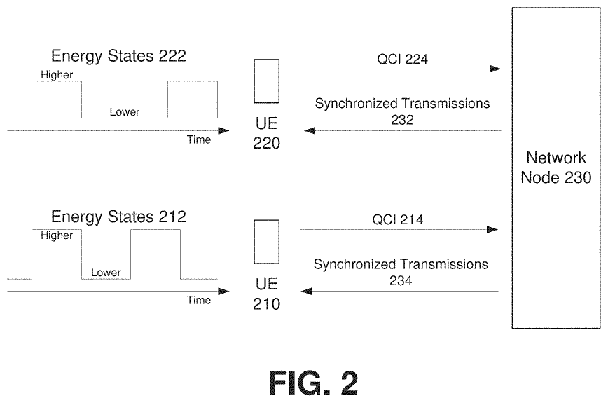

FIG. 2 illustrates example discontinuous reception interval adjustment, in accordance with various aspects and embodiments of the subject disclosure. FIG. 2 includes a network node 230 and two example UEs 210 and 220. The network node 230 can implement the network node 104 introduced in FIG. 1, and the UEs 210 and 220 can implement the UEs 102 introduced in FIG. 1. FIG. 2 furthermore illustrates energy states 212 of the UE 210, and energy states 222 of the UE 220. The UE 210 sends a QCI 214 to the network node 230, and the network node 230 sends synchronized transmissions 234 to the UE 210. The UE 220 sends a QCI 224 to the network node 230, and the network node 230 sends synchronized transmissions 232 to the UE 220.

In FIG. 2, the QCI 214 can be used by network node 230 to set timing of the synchronized transmissions 234, so that synchronized transmissions 234 are synchronized with the energy states 212 of the first UE 210. Likewise, the QCI 224 can be used by network node 230 to time the synchronized transmissions 232, so that synchronized transmissions 232 are synchronized with the energy states 222 of the second UE 220. The UEs 210 and 220 can be configured, e.g., during provisioning of the UEs 210, 220, to employ the respective energy states 212, 222 as well as to provide the respective QCIs 214, 224 to the network node 230 as described herein.

The energy states 212 of the UE 210 include higher and lower energy states according to a first discontinuous reception interval, while the energy states 222 of the UE 220 include higher and lower energy states according to a second, different discontinuous reception interval. The UEs 210, 220 can receive certain transmissions from the network node 230 during the higher energy states, but not during the lower energy states. For example, during the higher energy states, the UEs 210, 220 can monitor a physical downlink control channel (PDCCH), while the UEs 210, 220 do not monitor the PDCCH during the lower energy states.

The use of the lower energy states reduces energy consumption at the UEs 210, 220. Longer low energy states, such as illustrated in the energy states 222, better reduce energy consumption but also increase overall latency of the synchronized transmissions 232. Very low latency is not necessary for some UEs, and so the use of longer low energy states is generally desirable for UEs such as UE 220, e.g., to preserve battery life.

A shortened low energy state, such as illustrated in the energy states 212, results in higher energy consumption but also decreases the overall latency of the synchronized transmissions 234. Therefore, UEs requiring low latency can be configured to use QCI 214 and corresponding energy states 212. The discontinuous reception interval implemented by energy states 212 is referred to herein as a “shortened discontinuous reception interval” because the duration of the lower energy states is shorter than the duration of the lower energy states in, e.g., the discontinuous reception interval implemented by energy states 222.

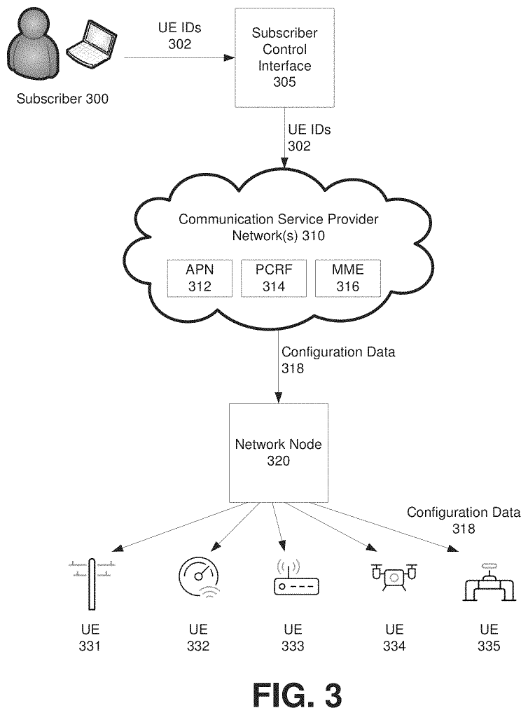

This disclosure is not limited to any particular discontinuous reception intervals. In some examples, a “long” discontinuous reception interval which can provide for lower energy consumption for UE 220 can be, e.g., 50 milliseconds (ms) to 350 ms. The long discontinuous reception interval can be a standard (default) discontinuous reception interval for UEs. A “short” discontinuous reception interval which can provide for low latency for UE 210 can be, e.g., 0 ms (in which case the UE 210 remains continuously in the higher energy state) to 50 ms. The short discontinuous reception interval can be assigned to UEs as needed. In some embodiments, a subscriber control interface such as illustrated in FIG. 3 can allow subscribers to assign a shortened discontinuous reception interval to the subscriber's UEs.

Embodiments of this disclosure achieve discontinuous reception interval adjustment on a UE by UE basis, by configuring different UEs 210, 220 to employ different energy states 210, 222 and corresponding different QCIs 214, 224 according to different discontinuous reception intervals. Furthermore, network nodes such as network node 230 can be configured to synchronize transmissions with different UEs 210, 220 according to QCIs 214, 224 received from the UEs 210, 220.

The use of QCIs 214, 224 for discontinuous reception interval adjustment, as described herein, can optionally be accompanied by also using QCIs 214, 224 to ensure network traffic from different UEs 210, 220 is allocated an appropriate quality of service (QoS), or by any other prior uses of QCIs or other uses of QCIs which may be developed in the future. In some embodiments, a QCI which is currently in use to designate high priority QoS, such as QCIs 6, 7, or 8, can be additionally used in connection with discontinuous reception interval adjustment according to this disclosure. In other embodiments, a new QCI can be allocated for use in connection with discontinuous reception interval adjustment according to this disclosure, and the new QCI can optionally be used to designate QoS level as well as a shortened discontinuous reception interval.

FIG. 2 illustrates the use of two QCIs 214, 224 to designate discontinuous reception intervals for UEs 210, 220. In some embodiments, a single QCI 214 can be used to designate a shortened discontinuous reception interval, while all other QCIs can be associated with a longer, default discontinuous reception interval. Furthermore, embodiments of this disclosure need not be limited to the use of two different discontinuous reception intervals. In some embodiments, additional QCIs can be used to designate additional discontinuous reception intervals, e.g., three or more different discontinuous reception intervals.

To implement discontinuous reception intervals, the user equipment 210, 220 and the network node 230 can negotiate phases, namely, the timing of higher energy states, in which data transfer can occur. During other times, namely, the lower energy states, the user equipment 210, 220 can turn their receivers off and enter a low power state. In some embodiments, synchronized transmissions 232, 234 can be structured to comprise slots with headers containing address details so that user equipment 210, 220 can listen to headers in each slot to decide whether a transmission is relevant to the user equipment 210, 220. Receivers at user equipment 210, 220 can be active at the beginning of each slot to receive the header, conserving battery life. In a polling approach, the user equipment 210, 220 can be placed into standby, i.e., the lower energy state, for a given amount of time and a beacon can be sent by the network node 230 periodically, to indicate if there is any waiting data for the user equipment 210, 220.

FIG. 3 illustrates example provisioning of user equipment to use an adjusted discontinuous reception interval, in accordance with various aspects and embodiments of the subject disclosure. FIG. 3 includes a subscriber 300 and a subscriber control interface 305. FIG. 3 further includes communication service provider network(s) 310 comprising an access point name (APN) 312, a policy and rules charging function (PCRF) 314, and a mobility management entity (MME) 316. Communication service provider network(s) 310 can implement the communication service provider network(s) 106 introduced in FIG. 1. FIG. 3 also includes a network node 320 and UEs 331, 332, 333, 334 and 335, wherein network node 320 can implement the network node 104 introduced in FIG. 1, and UEs 331-335 can implement the UEs 102 introduced in FIG. 1.

In FIG. 3, the subscriber 300 can provide UE identifiers (IDs) 302 to the subscriber control interface 305. The UE IDs 302 can identify those of the subscriber's UEs for which the subscriber 300 desires very low latency. For example, the UE IDs 302 can identify UEs 331-335. The subscriber control interface 305 can be configured to provide the UE IDs 302 to the communication service provider network(s) 310.

The communication service provider network(s) 310 can be configured to provision or otherwise configure elements of the communication service provider network(s) 310, such as APN 312, PCRF 314, and MME 316, to use the shortened discontinuous reception interval in connection with UEs 331-335 identified by UE IDs 302. The communication service provider network(s) 310 can also provision or otherwise configure the UEs 331-335 identified by UE IDs 302 to use the shortened discontinuous reception interval. The communication service provider network(s) 310 can provide configuration data 318 to network node 320, and the network node 320 can provide the configuration data 318 to UEs 331-335. The configuration data 318 can configure the UEs 331-335 to employ energy states such as energy states 212 according to the shortened discontinuous reception interval, and the configuration data 318 can configure the UEs 331-335 to use a QCI such as QCI 214 according to the shortened discontinuous reception interval.

The UEs 331-335 illustrated in FIG. 3 include IoT type UEs, which can have very low latency requirements. Example UEs 331-335 include utility user equipment, such as user equipment for electrical, water, gas, oil, communications or other utilities. Example utility user equipment can include switches, meters, sensors, valves, transmitters, or other user equipment which can be configured as a UE that communicates via a cellular communication network. In some cases, such user equipment can comprise devices which are installable at a fixed location and connectable to a continuous power supply. For UEs that have a continuous hard wired or plugged-in type power supply rather than operating on battery power, the increased power consumption associated with use of a shortened discontinuous reception interval does not lead to concerns regarding battery life. Further example UEs that can have low latency requirements beneficially served by embodiments of this disclosure include vehicle electronics, drones, and augmented reality/virtual reality (AR/VR) headsets or other devices.

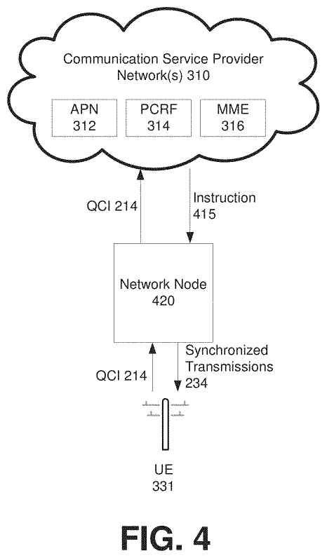

After the communication service provider network(s) 310 and UEs 331-335 are configured to use the shortened discontinuous reception interval, the UEs 331-335 can use the shortened discontinuous reception interval QCI, e.g., QCI 214, in their communications with network nodes, such as network node 320. The use of a shortened discontinuous reception interval QCI in connection with UE communications with network nodes is described further with reference to FIG. 4.

FIG. 4 illustrates example operations of a network node in connection with discontinuous reception interval adjustment, in accordance with various aspects and embodiments of the subject disclosure. FIG. 4 includes the communication service provider network(s) 310, APN 312, PCRF 314, MME 316, and UE 331 introduced in FIG. 3. FIG. 4 furthermore includes a network node 420, wherein the network node 420 can implement the network node 104 introduced in FIG. 1.

After the communication service provider network(s) 310 and UEs 331-335 are configured to use the shortened discontinuous reception interval, as described with reference to FIG. 3, the UEs 331-335 can use the shortened discontinuous reception interval QCI, e.g., QCI 214, in their communications with network nodes, such as network node 420. In FIG. 4, the UE 331 can include QCI 214 in a communication to network node 420. In response to receiving the QCI 214 from the UE 331, the network node 420 can forward the QCI 214 to communication service provider network(s) 310. The communication service provider network(s) 310 can process the QCI 214 information using elements such as the APN 312, PCRF 314, and/or MME 316, and the APN 312, PCRF 314, and/or MME 316 can generate an instruction 415 for the network node 420. The instruction 415 can specify a discontinuous reception interval associated with the QCI 214 to use in connection with network node 420 communications to UE 331. The communication service provider network(s) 310 can provide the instruction 415 to the network node 420.

The network node 420 can be configured to implement the instruction 415 by subsequently using synchronized transmissions 234 in connection with transmissions to the UE 331, wherein the synchronized transmissions 234 use the discontinuous reception interval associated with the QCI 214. In some embodiments, the duration of the shortened discontinuous reception interval for use with the UE 331 can be customized for UE 331 and/or for any UEs associated with a subscriber 300, e.g., by configuring a subscriber-specific APN which includes custom subscriber discontinuous reception interval information for use with QCI 214.

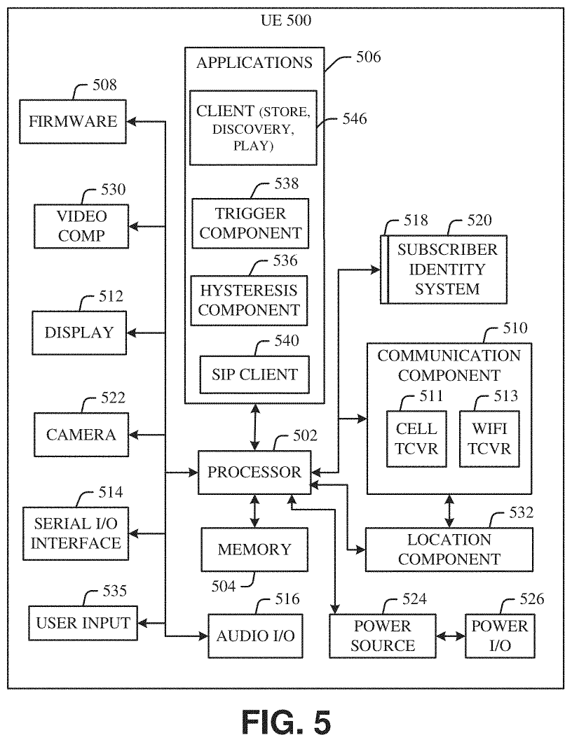

FIG. 5 illustrates an example user equipment which can be adapted to use an adjusted discontinuous reception interval, in accordance with various aspects and embodiments of the subject disclosure. The UE 500 can implement, e.g., either of the UEs 102 illustrated in FIG. 1. The example UE 500 generally includes features of a mobile handset, however, UE 500 can be adapted to provide other devices, including the UEs 331-335 described in connection with FIG. 3, as will be appreciated. In general, UE 500 can be operable to engage in a system architecture that facilitates wireless communications according to one or more embodiments described herein. The following discussion is intended to provide a brief, general description of an example of a suitable environment in which the various embodiments can be implemented.

The UE 500 includes a processor 502 for controlling and processing all onboard operations and functions. A memory 504 interfaces to the processor 502 for storage of data and one or more applications 506 (e.g., a video player software, user feedback component software, etc.). Other applications can include voice recognition of predetermined voice commands that facilitate initiation of the user feedback signals. The applications 506 can be stored in the memory 504 and/or in a firmware 508, and executed by the processor 502 from either or both the memory 504 or/and the firmware 508. The firmware 508 can also store startup code for execution in initializing the UE 500.

A communications component 510 interfaces to the processor 502 to facilitate wired/wireless communication with external systems, e.g., cellular networks, VoIP networks, and so on. Here, the communications component 510 can also include a suitable cellular transceiver 511 (e.g., a GSM transceiver) and/or an unlicensed transceiver 513 (e.g., Wi-Fi, WiMax) for corresponding signal communications. The UE 500 can be a device such as a cellular telephone, a PDA with mobile communications capabilities, and messaging-centric devices. The communications component 510 can also facilitate communications reception from terrestrial radio networks (e.g., broadcast), digital satellite radio networks, and Internet-based radio services networks.

The communications component 510 can be adapted by the processor 502 according to configuration data 318 introduced in FIG. 3, so that the cell transceiver 511 and/or the Wi-Fi transceiver 513 enters higher and lower energy states according to a discontinuous reception interval specified by the configuration data 318. Furthermore, the processor 502, in conjunction with an operating system or other applications 506, can be configured to cause communication component 510 to provide a QCI such as QCI 214 to a network node 230 along with other network communications.

The UE 500 can include a display 512 for displaying text, images, video, telephony functions (e.g., a Caller ID function), setup functions, and for user input. For example, the display 512 can also be referred to as a “screen” that can accommodate the presentation of multimedia content (e.g., music metadata, messages, wallpaper, graphics, etc.). The display 512 can also display videos and can facilitate the generation, editing and sharing of video quotes.

A serial I/O interface 514 is provided in communication with the processor 502 to facilitate wired and/or wireless serial communications (e.g., USB, and/or IEEE 1294) through a hardwire connection, and other serial input devices (e.g., a keyboard, keypad, and mouse). This supports updating and troubleshooting the UE 500, for example. Audio capabilities can be provided with an audio I/O component 516, which can include a speaker for the output of audio signals related to, for example, indication that the user pressed the proper key or key combination to initiate the user feedback signal. The audio I/O component 516 also facilitates the input of audio signals through a microphone to record data and/or telephony voice data, and for inputting voice signals for telephone conversations.

The UE 500 can include a slot interface 518 for accommodating a SIC (Subscriber Identity Component) in the form factor of a card Subscriber Identity Module (SIM) or universal SIM 520, and interfacing the SIM card 520 with the processor 502. However, it is to be appreciated that the SIM card 520 can be manufactured into the UE 500, and updated by downloading data and software.

The UE 500 can process IP data traffic through the communications component 510 to accommodate IP traffic from an IP network such as, for example, the Internet, a corporate intranet, a home network, a person area network, etc., through an ISP or broadband cable provider. Thus, VoIP traffic can be utilized by the UE 500 and IP-based multimedia content can be received in either an encoded or a decoded format.

A video processing component 522 (e.g., a camera) can be provided for decoding encoded multimedia content. The video processing component 522 can aid in facilitating the generation, editing, and sharing of video quotes. The UE 500 also includes a power source 524 in the form of batteries and/or an AC power subsystem, which power source 524 can interface to an external power system or charging equipment (not shown) by a power I/O component 526.

The UE 500 can also include a video component 530 for processing video content received and, for recording and transmitting video content. For example, the video component 530 can facilitate the generation, editing and sharing of video quotes. A location tracking component 532 facilitates geographically locating the UE 500. As described hereinabove, this can occur when the user initiates the feedback signal automatically or manually. A user input component 534 facilitates the user initiating the quality feedback signal. The user input component 534 can also facilitate the generation, editing and sharing of video quotes. The user input component 534 can include such conventional input device technologies such as a keypad, keyboard, mouse, stylus pen, and/or touch screen, for example.

Referring again to the applications 506, a hysteresis component 536 facilitates the analysis and processing of hysteresis data, which is utilized to determine when to associate with the access point. A software trigger component 538 can be provided that facilitates triggering of the hysteresis component 536 when the Wi-Fi transceiver 513 detects the beacon of the access point. A SIP client 540 enables the UE 500 to support SIP protocols and register the subscriber with the SIP registrar server. The applications 506 can also include a client 542 that provides at least the capability of discovery, play and store of multimedia content, for example, music.

The UE 500, as indicated above related to the communications component 510, includes an indoor network radio transceiver 513 (e.g., Wi-Fi transceiver). This function supports the indoor radio link, such as IEEE 802.11, for the dual-mode GSM UE 500. The UE 500 can accommodate at least satellite radio services through a handset that can combine wireless voice and digital radio chipsets into a single handheld device. The techniques disclosed herein can optionally be applied in connection with indoor network radio transceiver 513, cell transceiver 511, or other wireless radio transceivers in the UE 500.

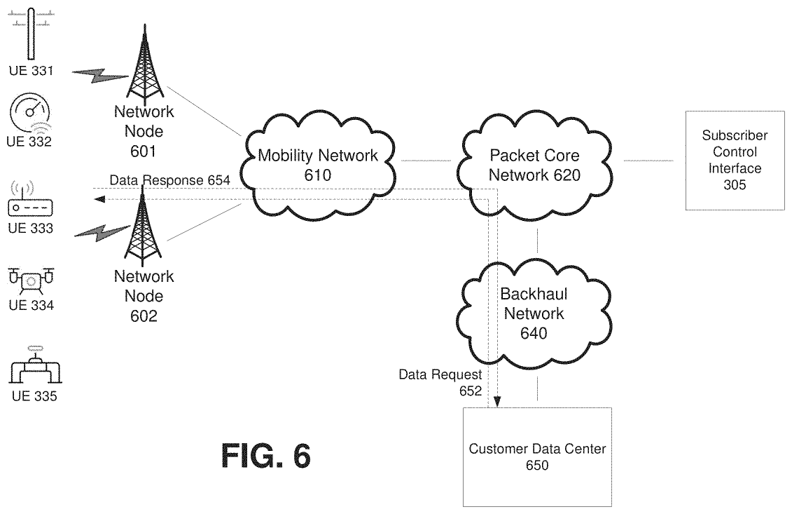

FIG. 6 illustrates an example network architecture configured to make use of discontinuous reception interval adjustment, in accordance with various aspects and embodiments of the subject disclosure. FIG. 6 includes the UEs 331-335 introduced in FIG. 3, as well as network nodes 601 and 602, each of which can implement a network node 104 introduced in FIG. 1. FIG. 6 further includes a mobility network 610, a packet core network 620, and a backhaul network 640, which can implement communication service provider network(s) 106 introduced in FIG. 1. A customer data center 650 can connect to backhaul network 640, and a subscriber control interface 305, introduced in FIG. 3, can connect to packet core network 620.

In FIG. 6, the subscriber control interface 305 can initiate provisioning of UEs 331-335 as described in connection with FIG. 3. After the UEs 331-335 are configured to use a shortened discontinuous reception interval, a data request 652 can originate from customer data center 650 and traverse the mobility network 610, packet core network 620, backhaul network 640, and network node 601 or 602 to one of UEs 331-335. The receiving UE can provide a data response 654 which returns to the customer data center 650 via the network node 601 or 602, the mobility network 610, packet core network 620, and the backhaul network 640. Through the use of a shortened discontinuous reception interval according to the techniques disclosed herein, the average round-trip latency experienced in round trips comprising data request 652 and data response 654 can be reduced.

Some embodiments according to this disclosure can solve a latency issue for IoT utility customers (electric, gas, water, oil, etc.) Utility customers may use a solution known as supervisory control and data acquisition (SCADA) or other computer system for gathering and analyzing real time data across the grid. SCADA relies on a poll/response style methodology in which a server in the upstream utility network, e.g., in customer data center 650, polls a static IP mobile terminated device, such as UE 331 for its current condition/parameters. In some use cases such as distribution automation, the UE 331 preferably responds in as close to real time as possible to account for various impacts and conditions. A standard traffic flow can therefore include a poll request in the form of data request 652 (e.g., an average 30-byte packet) from an upstream server at customer data center 650 sent to a UE 331 on a RAN network via a private static mobile terminated APN. The UE 331 is expected to respond with by providing a data response 654 with the requested data.

In an architecture such as illustrated in FIG. 6, custom discontinuous reception interval parameters can be applied to different QCI indexes. Embodiments can implement a new or currently non-used QCI index in which a very low discontinuous reception interval cycle time (e.g., 20 ms) is used for some UEs, without impacting a core customer base using other UEs that continue to use a standard discontinuous reception interval.

In an aspect, customized discontinuous reception interval parameter timers can be associated with a unique QCI set of parameters tied to a customer specific APN. Embodiments can customize the discontinuous reception interval parameters such to use shorter intervals than used for the general consumer network, while optionally still allowing a desired amount of power savings. Embodiments can tailor discontinuous reception interval settings to specific individual customer use cases, for example, utility infrastructure monitoring can use a 40 ms interval instead of, e.g., 320 ms, allowing utilities to meet their response time requirements.

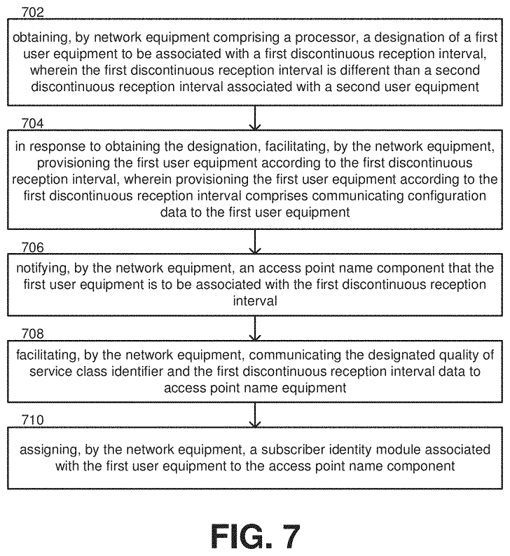

FIG. 7 is a flow diagram representing example operations of network equipment in connection with provisioning user equipment for discontinuous reception interval adjustment, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 7 can be performed, for example, by network equipment within communication service provider network(s) 310, illustrated in FIG. 3. At 702, the network equipment can obtain a designation of a first user equipment, e.g. a UE ID among UE IDs 302 that designates a first UE 331, wherein the first UE 331 is to be associated with a first discontinuous reception interval. The designation of the first user equipment 331 to be associated with the first discontinuous reception interval can be based on subscriber 300 user input received via a subscriber control interface 305.

The first discontinuous reception interval can be different than a second discontinuous reception interval associated with a second user equipment. The second user equipment can comprise, e.g., a UE 220 that is not identified in the UE IDs 302 and remains associated with a default longer discontinuous reception interval. The first discontinuous reception interval can be shorter than the second discontinuous reception interval, for example, the first discontinuous reception interval can be from 0 to about 40 ms, while the second discontinuous reception interval can be, e.g., 80 ms or longer.

At 704, in response to obtaining the designation obtained at 702, the network equipment can facilitate provisioning the first user equipment 331 according to the first discontinuous reception interval. Provisioning the first user equipment 331 according to the first discontinuous reception interval can comprise, e.g., communicating configuration data 318 to the first user equipment 331.

The configuration data 318 can comprise first discontinuous reception interval data usable to configure the first user equipment 331 to employ different energy states, e.g., energy states 212 of the first user equipment 331 in accordance with the first discontinuous reception interval. The different energy states 212 of the first user equipment 331 can comprise a first energy state and a second energy state, wherein the first energy state is higher than the second energy state.

The configuration data 318 can further comprise a designated QCI, e.g., QCI 214, wherein the first user equipment 331 is configured to communicate the designated QCI 214 to radio access network node equipment, such as network node 230, 320, or 420, in order to synchronize transmissions from the radio access network node equipment 230, 320, or 420 in accordance with the different energy states 212 of the first user equipment 331. Transmissions from the radio access network node equipment 230, 320, or 420 can be synchronized in accordance with the different energy states 212 of the first user equipment 331 by timing the transmissions from the radio access network node equipment 230, 320, or 420 to occur during the first energy (higher) state.

Operations 706, 708, and 710 include example further operations that the network equipment can perform to configure the communication service provider network(s) 310 to support the use of the first discontinuous reception interval by the user equipment 331. At 706, the network equipment can optionally also notify an APN component 312 that the first user equipment 331 is to be associated with the first discontinuous reception interval. At 708, the network equipment can optionally also facilitate communicating the designated QCI 214 and the first discontinuous reception interval data to the APN equipment 312. At 710, the network equipment can optionally also assign a subscriber identity module associated with the first user equipment 331 to the APN component 312.

In some examples, in addition to being associated with the first discontinuous reception interval, the designated QCI 214 can be associated with a priority level to be used by the RAN node equipment 320 in connection with processing communications from the first user equipment 331.

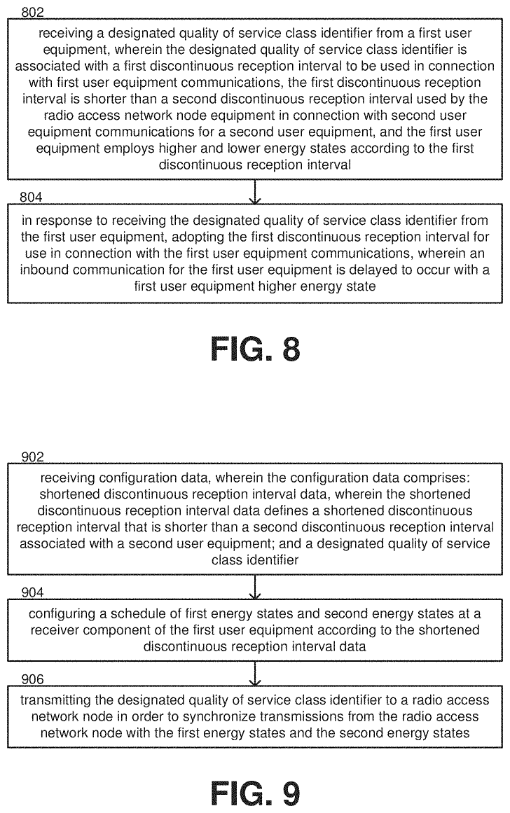

FIG. 8 is a flow diagram representing example operations of a network node in connection with transmissions to user equipment that employs an adjusted discontinuous reception interval, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 8 can be performed, for example, by radio access network node equipment 420, illustrated in FIG. 4. The radio access network node equipment 420 can optionally be configured to communicate according to a fourth generation (4G) network communication protocol.

At 802, the radio access network node equipment 420 can receive a designated QCI 214 from a first user equipment 331. The designated QCI 214 can be associated with a first discontinuous reception interval to be used in connection with first user equipment 331 communications, and the first user equipment 331 can employ higher and lower energy states, e.g., energy states 212, according to the first discontinuous reception interval.

The first discontinuous reception interval can be, e.g., shorter than a second discontinuous reception interval used by the radio access network node equipment 420 in connection with second user equipment communications for a second user equipment, such as UE 220. For example, in some embodiments, the first discontinuous reception interval can be less than or equal to about 40 ms. The designated QCI 214 can also optionally be associated with a priority level to be used by the radio access network node 420 in connection with processing communications from the first user equipment 331.

At 804, in response to receiving the designated QCI 214 from the first user equipment 331, the radio access network node equipment 420 can adopt the first discontinuous reception interval for use in connection with the first user equipment 331 communications. For example, an inbound communication for the first user equipment 311 (inbound from communication service provider network(s) 310 to network node 420) can be delayed to occur with a first user equipment 331 higher energy state. Adopting the first discontinuous reception interval for use in connection with the first user equipment 331 communications can comprise, e.g., receiving an instruction from an APN 312, PCRF 314, and/or MME 316.

FIG. 9 is a flow diagram representing example operations of user equipment in connection with using an adjusted discontinuous reception interval, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 9 can be performed, for example, by a first UE such as UE 210 illustrated in FIG. 2. In some embodiments, the first UE 210 can comprise an IoT type device installable at a fixed location and connectable to a continuous power supply. At 902, the UE 210 can receive configuration data such as configuration data 318, wherein the configuration data 318 comprises shortened discontinuous reception interval data and a designated QCI identifier 214.

The shortened discontinuous reception interval data can define a shortened discontinuous reception interval that is shorter than a second discontinuous reception interval associated with a second user equipment 220. The shortened discontinuous reception interval can be, e.g., from 0 to about 20 ms.

The designated QCI 214 can be for use in subsequent UE 210 communications with network nodes such as network node 230. In some embodiments, in addition to specifying the shortened discontinuous reception interval for use with UE 210, the designated QCI 214 can be associated with a priority level to be used by the radio access network node 230 in connection with processing communications from the first user equipment 210.

At 904, the UE 210 can configure a schedule of energy states 212, including first energy states and second energy states at a receiver component of the first user equipment 210 according to the shortened discontinuous reception interval data.

At 906, the UE 210 can transmit the designated QCI 214 to a radio access network node 230 in order to synchronize transmissions 234 from the radio access network node 230 with the first energy states and the second energy states.

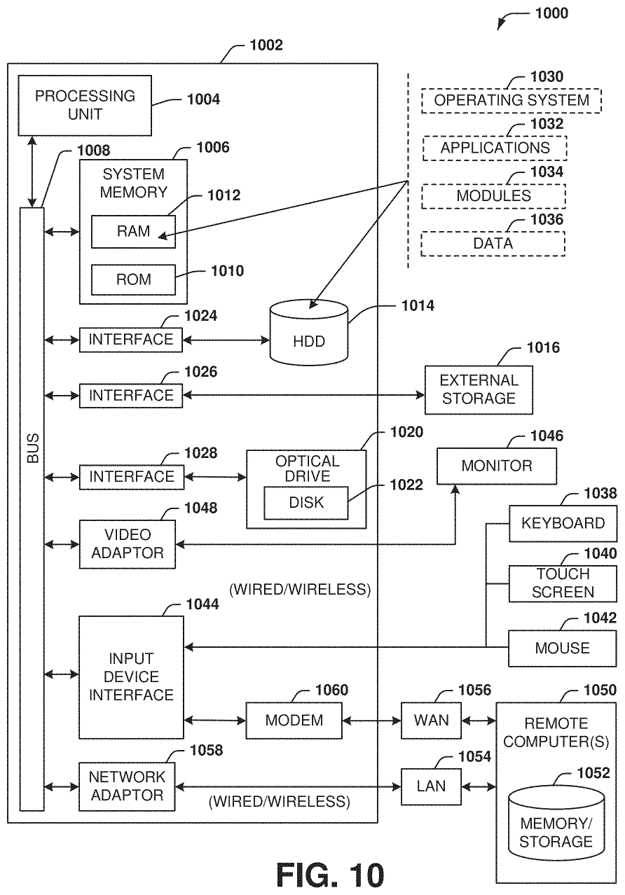

FIG. 10 is a block diagram of an example computer that can be operable to execute processes and methods in accordance with various aspects and embodiments of the subject disclosure. The example computer can be adapted to implement, for example, any of the various network equipment described herein.

FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), smart card, flash memory (e.g., card, stick, key drive) or other memory technology, compact disk (CD), compact disk read only memory (CD-ROM), digital versatile disk (DVD), Blu-ray™ disc (BD) or other optical disk storage, floppy disk storage, hard disk storage, magnetic cassettes, magnetic strip(s), magnetic tape, magnetic disk storage or other magnetic storage devices, solid state drives or other solid state storage devices, a virtual device that emulates a storage device (e.g., any storage device listed herein), or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
obtaining, by network equipment comprising a processor, a designation of a first user equipment to be associated with a first discontinuous reception interval, wherein the first discontinuous reception interval is different than a second discontinuous reception interval associated with a second user equipment; and
in response to obtaining the designation, facilitating, by the network equipment, provisioning the first user equipment according to the first discontinuous reception interval,
wherein provisioning the first user equipment according to the first discontinuous reception interval comprises communicating configuration data to the first user equipment, and
wherein the configuration data comprises:
first discontinuous reception interval data usable to configure the first user equipment to employ different energy states of the first user equipment in accordance with the first discontinuous reception interval, and
a designated quality of service class identifier, wherein the first user equipment is configured to communicate the designated quality of service class identifier to radio access network node equipment in order to synchronize transmissions from the radio access network node equipment in accordance with the different energy states of the first user equipment.

2. The method of claim 1, wherein the first discontinuous reception interval is from 0 to about 40 milliseconds.

3. The method of claim 1, wherein the designated quality of service class identifier is associated with a priority level to be used by the radio access network node equipment in connection with processing communications from the first user equipment.

4. The method of claim 1, further comprising notifying, by the network equipment, an access point name component that the first user equipment is to be associated with the first discontinuous reception interval.

5. The method of claim 1, further comprising facilitating, by the network equipment, communicating the designated quality of service class identifier and the first discontinuous reception interval data to access point name equipment.

6. The method of claim 5, further comprising assigning, by the network equipment, a subscriber identity module associated with the first user equipment to the access point name component.

7. The method of claim 1, wherein the first discontinuous reception interval is shorter than the second discontinuous reception interval.

8. The method of claim 1, wherein the different energy states of the first user equipment comprise a first energy state and a second energy state, wherein the first energy state is higher than the second energy state, and wherein transmissions from the radio access network node equipment are synchronized in accordance with the different energy states of the first user equipment by timing the transmissions from the radio access network node equipment to occur during the first energy state.

9. The method of claim 1, wherein the designation of the first user equipment to be associated with the first discontinuous reception interval is based on subscriber user input received via a subscriber control interface.

10. Radio access network node equipment, comprising:
a processor; and
a memory that stores executable instructions that, when executed by the processor, facilitate performance of operations, comprising:
receiving a designated quality of service class identifier from a first user equipment, wherein:
the designated quality of service class identifier is associated with a first discontinuous reception interval to be used in connection with first user equipment communications,
the first discontinuous reception interval is shorter than a second discontinuous reception interval used by the radio access network node equipment in connection with second user equipment communications for a second user equipment, and
the first user equipment employs higher and lower energy states according to the first discontinuous reception interval; and
in response to receiving the designated quality of service class identifier from the first user equipment, adopting the first discontinuous reception interval for use in connection with the first user equipment communications, wherein an inbound communication for the first user equipment is delayed to occur with a first user equipment higher energy state.

11. The radio access network node equipment of claim 10, wherein the first discontinuous reception interval is less than or equal to about 40 milliseconds.

12. The radio access network node equipment of claim 10, wherein the designated quality of service class identifier is associated with a priority level to be used by the radio access network node in connection with processing communications from the first user equipment.

13. The radio access network node equipment of claim 10, wherein adopting the first discontinuous reception interval for use in connection with the first user equipment communications comprises receiving an instruction from a policy and charging rules function.

14. The radio access network node equipment of claim 10, wherein adopting the first discontinuous reception interval for use in connection with the first user equipment communications comprises receiving an instruction from a mobility management entity.

15. The radio access network node equipment of claim 10, wherein adopting the first discontinuous reception interval in connection with the first user equipment communications comprises receiving an instruction from an access point name gateway.

16. The radio access network node equipment of claim 10, wherein the radio access network node equipment is configured to communicate according to a fourth generation network communication protocol.

17. A non-transitory machine-readable medium, comprising executable instructions that, when executed by a processor of a first user equipment, facilitate performance of operations, comprising:
receiving configuration data, wherein the configuration data comprises:
shortened discontinuous reception interval data, wherein the shortened discontinuous reception interval data defines a shortened discontinuous reception interval that is shorter than a second discontinuous reception interval associated with a second user equipment, and
a designated quality of service class identifier;
configuring a schedule of first energy states and second energy states at a receiver component of the first user equipment according to the shortened discontinuous reception interval data; and
transmitting the designated quality of service class identifier to a radio access network node in order to synchronize transmissions from the radio access network node with the first energy states and the second energy states.

18. The non-transitory machine-readable medium of claim 17, wherein the shortened discontinuous reception interval is from 0 to about 20 milliseconds.

19. The non-transitory machine-readable medium of claim 17, wherein the designated quality of service class identifier is associated with a priority level to be used by the radio access network node in connection with processing communications from the first user equipment.

20. The non-transitory machine-readable medium of claim 17, wherein the first user equipment comprises a device installable at a fixed location and connectable to a continuous power supply.
